(19) United States
(12) Patent Application Publication
(10) Pub. No.: US 2019/0252671 A1
(43) Pub. Date: Aug. 15, 2019

(54) Silicon (Si) Modified Li2MnO3-LiMO2 (M=Ni, Mn, Co) Cathode Material For Lithium-Ion Batteries

(71) Applicant: GM GLOBAL TECHNOLOGY OPERATIONS LLC, Detroit, MI (US)

(72) Inventors: Yan WU, Troy, MI (US); Leah NATION, Cambridge, MA (US); Raghunathan K, Troy, MI (US)

(73) Assignee: GM GLOBAL TECHNOLOGY OPERATIONS LLC, Detroit, MI (US)

(21) Appl. No.: 15/894,368

(22) Filed: Feb. 12, 2018

(51) Int. Cl. H01M 4/131; H01M 10/0525; C01G 53/00

(52) U.S. Cl. CPC H01M 4/131; H01M 2004/028; C01G 53/50; H01M 10/0525

(57) ABSTRACT

A lithium ion battery has a positive electrode or cathode having a silicon modified mixed metal oxide including a compound having empirical formula

Li[Li_{y}Mnₐ₋ₓSiₓM^{III}_{b}M^{II}_{c}]O₂ (I)

wherein y=0.01-0.33; x=0.001-0.15; a, b, and c are each greater than zero; M^{III} is a trivalent metal or a combination of metals with an average valence of +3; M^{II} is a divalent metal or a combination of metals with an average valence of +2; and y+4a+3b+2c is equal to 3 or about 3. Such a silicon modified mixed metal oxide may be exemplified by formula: Li [Li_{0.2} Mn_{0.49} Si_{0.05} Ni_{0.13} Co_{0.13}]O₂.

### GOVERNMENT SUPPORT

This invention was made with government support under Grant No. DMR-1410946 awarded by the U.S. National Science Foundation. The Government has certain rights in the invention.

### BACKGROUND

This section provides background information related to the present disclosure which is not necessarily prior art.

The present disclosure relates to silicon-modified Li₂MnO₃—LiMO₂ (M=Ni,Mn,Co) cathode material for lithium ion batteries.

Lithium-ion batteries for battery electric vehicles (BEV) desirably have high energy density, long life, and exhibit safety. The cathode is an important component of the battery, because it is the limiting factor with respect to cell energy density and hence is a major determinant of the mass, volume, and cost of the battery. Lithium-rich layered oxides Li[Li_{x/3}Mn_{2x/3}M₁₋ₓ]O₂, alternatively designated as xLi₂Mn⁺⁴O₃.(1-x)LiMO₂ (M=Ni, Mn, Co) or HE-NMC, are attractive candidates as cathodes for lithium-ion batteries because they exhibit higher capacity (>250 mAh/g) and are less expensive than other commercially available cathode materials.

In spite of the high capacity of HE-NMC there remain fundamental challenges preventing its commercial application. These include voltage decay during cycling, short calendar and cycle life, and fast resistance rise at low state of charge (SOC). These challenges are related to the Mn-rich nature and the structural instability of these materials induced by the oxidation of oxygen. Indeed, considerable research has already been devoted to understanding the structural evolution of HE-NMC materials.

### SUMMARY

This section provides a general summary of the disclosure, and is not a comprehensive disclosure of its full scope or all of its features.

In certain variations, the present disclosure provides a silicon-modified metal oxide including a compound having empirical formula

Li[Li_{y}Mnₐ₋ₓSiₓM^{III}_{b}M^{II}_{c}]O₂ (I)

wherein
y=0.01-0.33;
x=0.001-0.15;
a, b, and c are each greater than zero;
M^{III} is a trivalent metal or a combination of metals with an average valence of +3;
M^{II} is a divalent metal or a combination of metals with an average valence of +2; and
y+4a+3b+2c is equal to 3 or about 3.

In one aspect, y≥0.02.

In one aspect, y≥0.05.

In one aspect, x≥0.02.

In one aspect, x≥0.05.

In one aspect, x≥0.07.

In one aspect, M^{III} includes Co and M^{II} includes Ni.

In one aspect, a>0.3.

In one aspect, a is 0.3-0.67.

In one aspect, a lithium ion battery is provided that includes an anode, a cathode, and a separator disposed between the anode and cathode. The cathode includes a mixed metal oxide compound according to any of the variations described above.

In one aspect, the mixed metal oxide has an empirical Formula (II):

Li[Li_{0.2}Mn_{0.49}Si_{0.05}Ni_{0.13}Co_{0.13}]O₂ (II).

In one aspect, a method for synthesizing a silicon-modified metal oxide according to any of the variations described above, includes:

combining soluble salts including Mn²⁺, Ni⁺², and Co⁺² in an aqueous solution;

co-precipitating hydroxide salts as solids from the aqueous solution with base;

collecting the co-precipitated solids;

combining the solids with lithium hydroxide and a silicon compound; and

calcining the resulting composition in air at a temperature sufficient to calcine the materials to make a composition according to any of the variations described above.

In one aspect, M^{III} includes Co and M^{II} includes Ni.

In one aspect, the method further includes calcining at a temperature of 600-1200° C.

In one aspect, the silicon compound includes silicic acid.

In one aspect, the silicon compound includes a siloxane or polysiloxane.

In one aspect, the silicon compound is a solid.

In certain other variations, the present disclosure provides a method of operating a lithium ion battery includes providing a lithium ion battery including an anode, a cathode, and a separator disposed between the cathode and anode. The cathode includes a battery active material prepared in a discharged state. A voltage difference is applied between the cathode and anode to de-lithiate the active material in the cathode and charge the lithium ion battery. The battery active material includes a mixed metal oxide having empirical formula

Li[Li_{y}Mnₐ₋ₓSiₓM^{III}_{b}M^{II}_{c}]O₂ (I)

wherein

y=0.01-0.33; a=0.3-0.67; x=0.001-0.15; and b and c are both greater than zero;

M^{III} is a trivalent metal or a combination of metals with an average valence of +3;

M^{II} is a divalent metal or a combination of metals with an average valence of +2; and

y+4a+3b+2c is equal to about +3 or about +3.

In one aspect, M^{III} includes cobalt and M^{II} includes nickel.

In one aspect, x≥0.01 and y≥0.1.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C show SEM images of control Li[Li_{0.2}Mn_{0.54}Ni_{0.13}CO_{0.13}]O₂ at FIG. 1A) 3kX and FIG. 1B) 30kX magnifications; FIG. 1B) SEM image of Li[Li_{0.2}Mn_{0.49}Si_{0.05}Ni_{0.13}Co_{0.13}]O₂ at 30kX;

FIG. 2 shows XRD patterns of pristine control, 2% Si, and 5% Si HE-NMC powders, where an asterisk (*) indicates peaks from Li₄SiO₄. The y-axis 108 shows counts (a.u.). The control is designated 110, the 2% Si sample is designated 112, and the 5% sample is designated 114;

FIGS. 3A-3B show Raman spectra of 3A) control, and 3B) 5% Si HE-NMC electrodes in the pristine state, after the first charge, and after the first discharge. In FIG. 3A, the y-axis 120 shows intensity (a.u.) and the x-axis 122 shows wavenumber (cm⁻¹). Pristine is designated 130, end of charge is designated 132, and end of discharge is designated 134. In FIG. 3B, the y-axis 140 shows intensity (a.u.) and the x-axis 142 shows wavenumber (cm⁻¹). Pristine is designated 150, end of charge is designated 152, and end of discharge is designated 154;

FIG. 4 presents first cycle voltage profiles of control and Si doped HE-NMC at C/20. The y-axis 160 shows intensity (a.u.) and the x-axis 162 shows capacity (mAh/g). The control is designated 170, the 2% Si sample is designated 172, and the 5% sample is designated 174;

FIG. 5 shows discharge capacity fade of control and Si doped HE-NMC cycled at C/3. The y-axis 180 shows discharge capacity (mAh/g) and the x-axis 182 shows cycle number. The control is designated 190, the 2% Si sample is designated 192, and the 5% sample is designated 194;

FIGS. 6A-6C show differential capacity plots of 6A) control, 6B) 2% Si, and 6C) 5% Si HE-NMC for every 10^{th} cycle. In FIG. 6A, the y-axis 200 shows dQ/dV (mAh/gV) and the x-axis 202 shows voltage (V). A first discharge is designated 210, a 12^{th} discharge is designated 212, a 23^{rd} discharge is designated 214, a 34^{th} discharge is designated 216, and a 45^{th} discharge is designated 218. In FIG. 6B, the y-axis 220 shows dQ/dV (mAh/gV) and the x-axis 222 shows voltage (V). A first discharge is designated 230, a 12^{th} discharge is designated 232, a 23^{rd} discharge is designated 234, a 34^{th} discharge is designated 236, and a 45^{th} discharge is designated 238. In FIG. 6C, the y-axis 240 shows dQ/dV (mAh/gV) and the x-axis 242 shows voltage (V). A first discharge is designated 250, a 12^{th} discharge is designated 252, a 23^{rd} discharge is designated 254, a 34^{th} discharge is designated 256, and a 45^{th} discharge is designated 258;

FIGS. 7A-7C show Nyquist plots of control and Si doped HE-NMC at 7A) open circuit potential, 7B) the end of the first charge, and 7C) the end of the first discharge. In FIG. 7A, the y-axis 260 shows −1 m (Ω) and the x-axis 262 shows Re (Ω). The control is designated 270, the 2% Si sample is designated 272, and the 5% sample is designated 274. In FIG. 7B, the y-axis 280 shows −1 m (Ω) and the x-axis 282 shows Re (Ω). The control is designated 290, the 2% Si sample is designated 292, and the 5% sample is designated 294. In FIG. 7C, the y-axis 300 shows −1 m (Ω) and the x-axis 302 shows Re (Ω). The control is designated 310, the 2% Si sample is designated 312, and the 5% sample is designated 314;

FIG. 8 shows DCR measurement results during a 30 s 1 C discharge pulse at 50% SOC for control and Si doped HE-NMC. The y-axis 320 shows voltage (V) and the x-axis 322 shows time (s). The control is designated 330, the 2% Si sample is designated 332, and the 5% sample is designated 334;

FIG. 9 shows a model of first charge mechanisms for control (right) and Si-doped (left) HE-NMC. Li[Li,M]O₂(M=Ni,Co,Mn,Si) is designated 340, as where Li[Li,M]O₂(M=Ni,Co,Mn) is designated 342. The charge to 4.4 V is designated 344, the charge along a 4.5 V plateau is designated 346, and the end of charge is designated 348. The oxygen vacancies in the lattice are designated 350, while the lattice densification is designated 352; and

FIG. 10 depicts an exemplary battery.

### DETAILED DESCRIPTION

Layered lithium-rich positive electrode or cathode materials xLi₂MnO₃.(1-x)LiMO₂ (M=Mn, Co, Ni), also named high energy NMC (HE-NMC) cathodes, have attracted considerable attention as a promising material for lithium ion batteries thanks to their high operating voltage (4.8 V) and specific capacity up to 280 mAh g⁻¹. The current teachings provide guidance how to overcome structural instability of the HE-NMC materials, and also address a fast resistance increase at a low stated charge using the former materials. In one aspect, Si is used to modify the HE-NMC material to obtain improved cathode materials for lithium ion batteries. Synthetic methods involve incorporating Si into the lithium manganese cobalt and nickel materials. The synthetic route results in a stabilized cathode material structure and leads to improved reversible capacity and reduced cell resistance.

New battery active cathode materials are provided that are mixed oxides of Formula (I)

Li[Li_{y}Mnₐ₋ₓSiₓM^{III}_{b}M^{II}_{c}]O₂ (I)

In Formula (I), y=0.01-0.33; a=0.3-0.67; x=0.001-0.2; a, b, c are all greater than zero; M^{III} is a trivalent metal or combination of metals with an average valence of +3; M^{II} is a divalent metal or a combination of metals with an average valence of +2; and y+4a+3b+2c=+3 or about +3. Thus, and y+4a+3b+2c is equal to about +3.

In a particular embodiment, M^{III} is cobalt and M^{II} is nickel. A synthetic method involves co-precipitation to form mixed hydroxides of nickel, cobalt, and manganese. The mixed hydroxides are collected and then dry mixed with lithium hydroxide and a silicon compound. Finally, the dry mix, including mixed hydroxides, of lithium hydroxide and silicon compound is heated, for example at 900° C. for a suitable time such as 12 hours to achieve a final product having the empirical Formula Li[Li_{0.2}Mn_{0.54}-xSiₓNi_{0.13}Co_{0.13}]O₂, wherein x is a small amount relative to 0.54, and represents a partial replacement of Mn⁺⁴ in the structure with silicon, which is also a tetravalent (+4) element.

Thus, in certain aspects, the current teachings contemplate silicon modified metal oxides comprising a compound describable by the empirical Formula (I):

Li[Li_{y}Mnₐ₋ₓSiₓM^{III}_{b}M^{II}_{c}]O₂ (I)

In Formula (I), the value of y ranges from 0.01-0.33, a is 0.3-0.67, x is from 0.001-0.2, and each of a, b, and c are greater than 0. Further, M^{III} is a trivalent metal or a combination of metals having an average valence of +3, while M^{II} is a divalent metal or a combination of metals having average valence of +2. Finally, the compound is charge balanced, requiring that the sum y+4a+3b+2c be about 3. In various embodiments, the sum ranges from about 2.8 to about 3.2, from about 2.9 to about 3.1, or from about 2.95 to about 3.05, reflecting experimental variation, rounding, and the like.

In further embodiments, y (which reflects an “excess” of lithium) is greater than or equal to 0.02 or y greater than or equal to 0.05. In various embodiments, x greater than or equal to 0.02, optionally x is greater than or equal to 0.05, or x is greater than or equal to 0.07. In certain variations, x is from 0.001-0.15. In illustrative embodiments, M^{III} comprises cobalt (Co) and M^{II} comprises nickel (Ni).

In various embodiments, the compounds of empirical Formula (I) are manganese rich, in that a is generally greater than 0.3, and illustratively may be in a range of about 0.3 to about 0.67, optionally about 0.5 to about 0.67.

In other embodiments, a lithium ion battery is provided that comprises a negative electrode or anode, a positive electrode or cathode, and a separator disposed between the anode and cathode. The cathode comprises a mixed metal oxide according to Formula (I). In a particular embodiment, the active material comprises a mixed metal oxide according to Formula (II)

Li[Li_{0.2}Mn_{0.49}Si_{0.05}Ni_{0.13}Co_{0.13}]O₂ (II)

The current teachings also provide methods for synthesizing the compounds of Formula (I) and Formula (II) as further described. A method for synthesizing a silicon-modified metal oxide according to Formula (II), comprises:

combining soluble salts comprising Mn²⁺, Ni⁺², and Co⁺² in an aqueous solution;

co-precipitating hydroxide salts as solids from the aqueous solution with base;

collecting the co-precipitated solids;

combining the solids with lithium hydroxide and a silicon compound; and

calcining the resulting composition in air at a temperature sufficient to calcine the materials to make a composition according to Formula (II).

More generally, to make compositions according to Formula (I), stoichiometric amounts of Li, Mn, and metals making up M^{II} and M^{III} are determined based on the subscripts a, b, c, x, and y in Formula (I). First, soluble salts of Mn²⁺ and other divalent metals are combined and dissolved in an aqueous solution in the proper stoichiometric ratios. These divalent metals include those that make up M^{II} in the final product and those that make up M^{III} in the final product. To that aqueous solution, a base (such as, without limitation, KOH) is added to co-precipitate hydroxide salts of the metals. At this stage the hydroxides are of metals in the +2 valence state. After co-precipitation, the solids are collected, for example on a filter. The solids are optionally dried and then combined and mixed with lithium hydroxide and a silicon compound. Finally, the mixture of hydroxides and silicon compound are calcined in air at a temperature sufficient to calcine the materials and make a composition according to Formula (I) or Formula (II).

The metals for the synthesis are selected to include Mn²⁺, which undergoes oxidation to a valence of +4; a metal or group of metals that changes from a valence state of +2 to a valence state of +3, and a metal or group of metals that remains unchanged with a valence state of +2. It is believed that the calcining conditions lead to these valence changes. In an exemplary embodiment, the synthetic conditions change Mn⁺² to Mn⁺⁴, and change Co⁺² to Co⁺³ while lithium remains at +1 and Si remains at +4 throughout the synthesis steps. In this way Mn⁺⁴, M^{III}, M^{II}, L⁺¹, and Si⁺⁴ are incorporated into compounds of Formula (I) or Formula (II).

The stoichiometry of the starting materials is selected to provide the mixed metal compounds illustrated in Formulas (I) and (II), taking account of the values of the variables y, x, a, b, and c. Notwithstanding, in some embodiments the lithium starting material is provided at a slight surplus over that suggested by its subscript y in Formulas (I) and (II), for example at or over an excess of 3% relative to the other starting materials. In particular embodiments, M^{III} is cobalt or a mixture of metals including cobalt, and/or M^{II} is nickel or a combination of elements including nickel.

The materials are calcined in air at a temperature sufficient to form the compounds. In various embodiments, the calcining conditions are sufficient to produce compounds wherein Mn is found in the +4 valence state and Co is found in the +3 valence, while Ni remains in the +2 state, unchanged from its starting value. To accomplish this, the materials are calcined in air at a suitable temperature such as about 600 to about 1200° C.

In the compounds and in the methods to make the compounds, silicon is provided at a low amount as a partial replacement for the +4 valence metal, illustrated in Formulas (I) and (II) as Mn⁺⁴. Thus, the magnesium rich materials are characterized by the variable “a” being present at a range of greater than or equal to 0.3, optionally greater than or equal to 0.4, or a greater than or equal to 0.5. In certain aspects, “a” may be greater than or equal to about 0.3 to less than or equal to about 0.67. The amount of silicon (Si), reflected by the variable “x” is selected to be a minor amount of the manganese fraction “a.” As detailed above, “x” may range from about 0.001 on the low end up to about 0.15 or about 0.2. In general, when the level “a” of Mn is in the lower end of its range of 0.3 to 0.67, the values of x are in the lower end of its range of 0.001 to 0.2. Conversely, when Mn is in the upper end of its range, so are the values of x for the amount of Si. In effect, the Si is incorporated into the structure of Formula (I) only at a small fractional percentage of the Mn in the structure, which it partially replaces. At these low levels it is believed the Si may even occupy the Mn sites in the crystalline material. As the Si level is increased, a point is reached at which the silicon doped material begins to show inhomogeneous Si distribution with microscopy. The observed material could be excess silicate material above what can be incorporated into Formula (I).

In non-limiting embodiments, x is 0.01, 0.02, 0.05, 0.07, 0.1, or 0.15. Essentially, a small portion of the manganese is substituted with silicon, which is another +4 material, but one which is not lithium active. The silicon compound may be a solid, and can be selected from silicic acid, without limitation. Other suitable silicon compounds include siloxanes, including silicon polymers such as polysiloxanes.

The battery active materials described herein are synthesized in a fully discharged state. Accordingly, a method for operating a lithium ion battery involves providing the battery with a cathode, anode and separator disposed between them, wherein the cathode comprises a battery active material prepared in discharged state according to the formulas set forth herein and the methods described. A voltage difference is supplied between the cathode and the anodes to de-lithiate the active material and charge the lithium ion battery.

Thus in one aspect, the current teachings are concerned with the choice of element being incorporated into the Li₂MnO₃—LiMO₂ (M=Ni,Mn,Co) material and the method of synthesis to stabilize the cathode material's crystal structure and decrease the cathode's resistance for improved Li-ion battery performance.

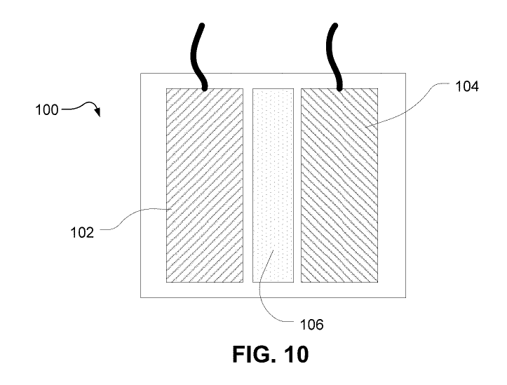

With reference to FIG. 10, the present teachings generally relate to high energy NMC materials subjected to silicon doping or silicon modifying to provide a battery active material having superior capacity relative to a control without silicon. In various embodiments, the silicon modified HE-NMC materials are used as part of a battery 100 as generically depicted in FIG. 10. The battery 100 includes the anode 102, a cathode 104, and a separator 106 containing electrolyte. While the battery of FIG. 10 is a simplified illustration, the electrode of the current teachings can be used as a cathode material in all lithium based batteries using metallic lithium or alternative anodes such as carbonaceous and graphitic anodes, lithium alloys, silicon based alloys, oxides, nitrides, phosphides, borides, and so on.

While various aspects of the inventive technology have been described with reference to various example embodiments, further non-limiting disclosure is given in the example section that follows.

### EXAMPLES

Synthesis

Li[Li_{0.2}Mn_{0.54}Ni_{0.13}Co_{0.13}]O₂ powders were synthesized by a co-precipitation method. The reactant quantities were calculated to give a Li₁₂Mn_{0.54}Ni_{0.13}Co_{0.13}O₂ control stoichiometry, with 3% excess lithium. Dopant quantities were calculated to substitute manganese at 2 and 5% doping levels, yielding Li[Li_{0.2}Mn_{0.52}Si_{0.02}Ni_{0.13}CO_{0.13}]O₂ (2% Si, where x=0.02) and Li[Li_{0.2}Mn_{0.49}Si_{0.05}Ni_{0.13}CO_{0.13}]O₂ (5% Si, where x=0.05), respectively. Manganese sulfate tetrahydrate (Sigma Aldrich), cobalt sulfate septahydrate (Sigma Aldrich), and nickel sulfate hexahydrate (Sigma Aldrich) precursors were dripped into a potassium hydroxide (Baker) solution and the precipitate was filtered, washed with deionized water, and dried in an 80° C. oven overnight. Lithium hydroxide and silicic acid (Sigma Aldrich) were measured and ground with the dried transition metal precipitate using a mortar and pestle for 30 minutes. The ground powder was placed in a crucible and calcined in a furnace at 900° C. for 12 hours.

Material Characterization

The structure was determined using X-ray powder diffraction measurements made on a Bruker D8 Advance with Cu K-alpha radiation in the 20 theta range of 10° to 90° at a step rate of 0.01°/s. Scanning electron microscopy (SEM) images were conducted to investigate the morphology of the material. Electrode powders were attached to the aluminum stub using two-sided conductive carbon tape. A conductive gold-palladium alloy was sputter deposited onto the powders for 8 seconds using a Denton 11 sputter deposition system. Images were obtained using a Hitachi s-4800 SEM with 5 kV accelerating voltage, 5 mm working distance and the inlens detector. A Thermoscientific Nicolet Almega XR dispersive Raman was used with a 532 nm wavelength source, 20× objective and 100 μm aperture to characterize structural changes in electrodes at various points in the first cycle ex situ. Two samples per condition and two locations per sample were analyzed. To ensure the beam was not damaging the sample and changing the signal, the same location on the same sample was collected twice and the response was unchanged.

Electrochemical Characterization

Slurries were made with an 80:10:10 formulation of active material to PVDF binder (Kynar) to Super P conductive carbon (Timcal) in 1-methyl-2-pyrrolidone (Sigma Aldrich) mixed in a Thinky planetary mixer. Electrodes were made by coating the slurry on aluminum foil with a wet 10 mil drawdown bar, dried in an 80° C. oven overnight, and stored in the oven until ready for use. Electrodes were punched to a 12.7 mm diameter. Al-clad CR2032-type coin cells were assembled in an argon filled glovebox (Vacuum Atmospheres Co.) using Li counter electrode, ¾″ diameter Cellgard 2325, and 150 μl of 1M LiPF₆ 1/1 (vol.) EC/EMC (BASF) electrolyte. Electrochemical testing was performed at 30° C. using Maccor 4000 series battery cyclers. Samples were cycled with an initial C/20 rate followed two cycles at C/10, then C/3 cycling in a 2-4.6 V vs. Li/Li⁺ voltage window, where the 1 C current depends on the active material mass and averages 2 mA. Differential capacity measurements were conducted at a C/100 rate. Direct Current Resistance (DCR) is a useful tool to assess batteries for electric vehicle applications. In the DCR measurement, cells were discharged at C/20 to 50% state of charge (SOC), allowed to rest one hour, and discharged at 1 C for 30 s. AC impedance spectra were recorded with a Biologic VMP3 in the 1 MHz-10 mHZ range with 10 points per decade. Cells were built in duplicate or triplicate to confirm consistency of electrochemical performance. Cells were disassembled and cleaned in dimethyl carbonate (BASF) before postmortem characterization.

Results and Discussion

Material Characterization

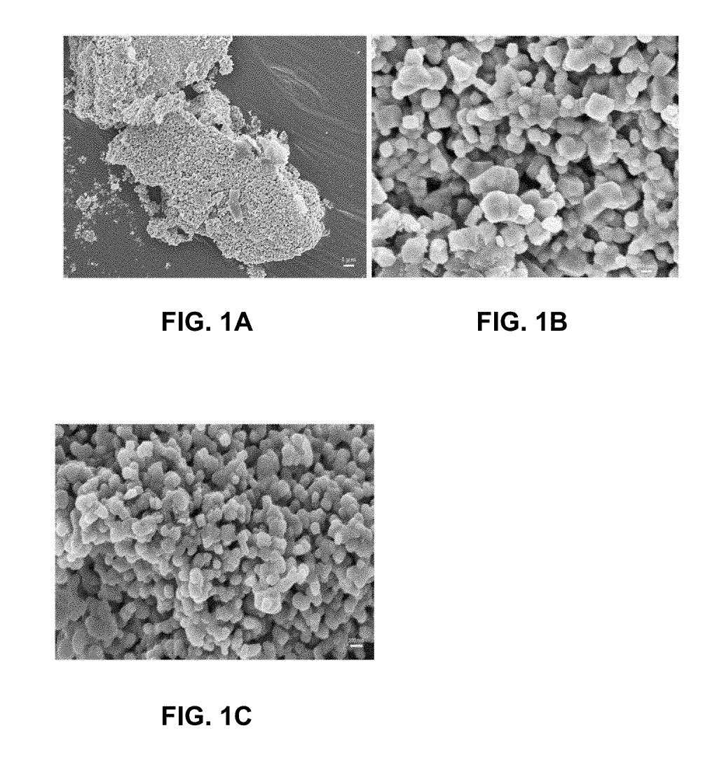

Li[Li_{0.2}Mn_{0.54}Ni_{0.13}Co_{0.13}]O₂ synthesized by the co-precipitation method results in large secondary particle agglomerations as seen in FIG. 1A, with primary particles approximately 100 nm in diameter (FIG. 1B). The small particle size reduces the Li+ diffusion distance, facilitating lithium extraction and insertion during electrochemical cycling. The morphology did not change with Si doping (FIG. 1C).

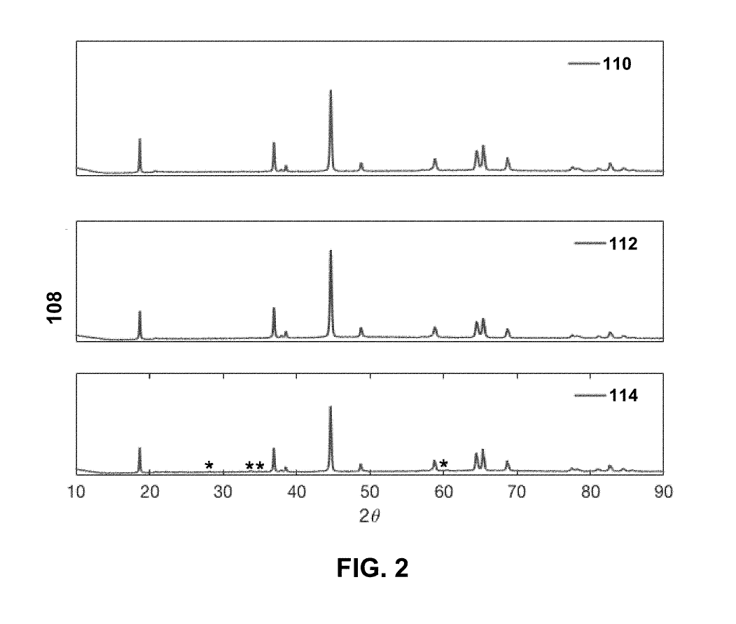

FIG. 2 shows XRD patterns of pristine control, 2% Si (where x is 0.02), and 5% Si (where x is 0.05) HE-NMC powders, where an asterisk (*) indicates peaks from Li₄SiO₄. The y-axis 108 shows counts (a.u.). The control is designated 110, the 2% Si sample is designated 112, and the 5% sample is designated 114. All sample patterns match the α-NaFeO₂ type layered structure (R3̅m space group). The 5% Si HE-NMC pattern shows trace amount of Li₄SiO₄, indicated with asterisks. The small reflection peaks around 2θ=20° correspond to cation ordering in the transition metal layer in the Li₂MnO₃ phase, belonging to the C2/m space group. Splitting of the (006/012) and (018)/(110) peaks indicates the samples have highly ordered layered structures. Table 1 lists the lattice parameters of the three HE-NMC samples obtained from Rietveld refinements. The a and c parameters increase as the Si doping level increases, as observed in Si-doped LiNiₓMn_{y}Co_{1-x-y}O₂. Furthermore, the a/c ratio increases with the doping level, suggesting that Si doping improves the layered structure.

TABLE 1
Lattice parameters of HE-NMC samples from Rietveld
refinement of the rhombohedral phase.

| Sample | a (Å) | c (Å) | c/a |
|---|---|---|---|
| Control | 2.8502 | 14.2234 | 4.9903 |
| 2% Si | 2.8515 | 14.2313 | 4.9908 |
| 5% Si | 2.8524 | 14.2448 | 4.9940 |

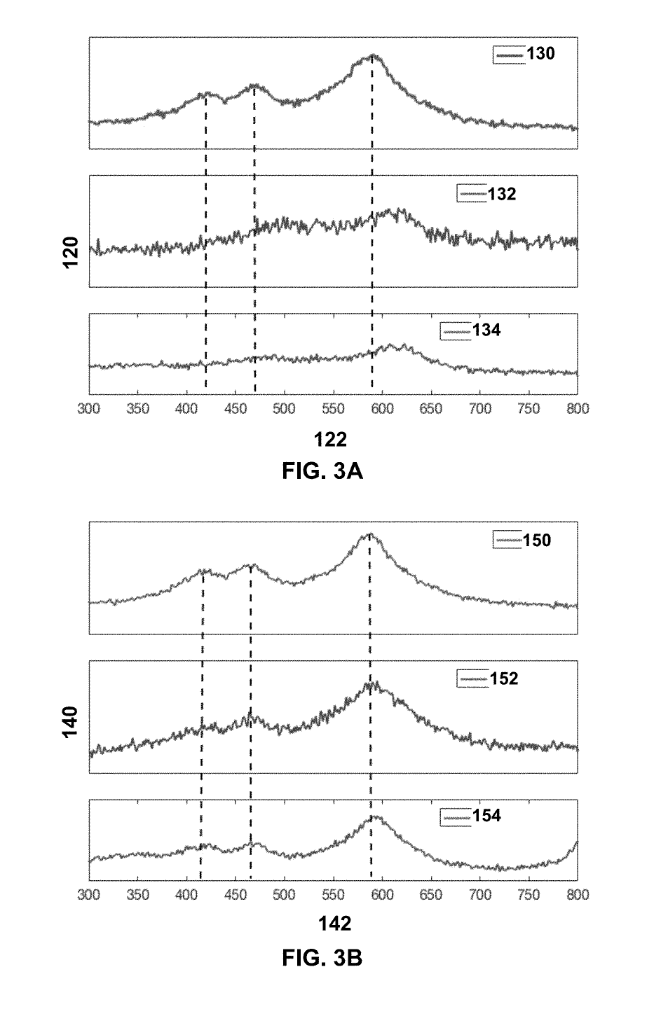

Raman is sensitive to small structure changes at the surface in nanoparticles, where the surface is volumetrically large. FIG. 3A shows the Raman spectra of control HE-NMC in the pristine condition, at the end of the first charge, and at the end of the first discharge. The pristine sample has a peak at 420 cm⁻¹ corresponding to Li₂MnO₃, 470 cm⁻¹ from E_{g} in plane metal-oxygen vibrations, and 590 cm⁻¹ corresponding to the A_{1g} transverse metal oxygen vibrations. By the end of the first charge the E_{g} and A_{1g} peaks have shifted to higher wavenumber and the peak from Li₂MnO₃ has disappeared. The blue shift of the metal-oxygen vibrations is indicative of spinel-like ordering.

FIG. 2 shows XRD patterns of pristine control, 2% Si, and 5% Si HE-NMC powders, where an asterisk (*) indicates peaks from Li₄SiO₄. The y-axis 108 shows counts (a.u.). The control is designated 110, the 2% Si sample is designated 112, and the 5% sample is designated 114;

FIGS. 3A-3B show Raman spectra of 3A) control, and 3B) 5% Si RE-NMC electrodes in the pristine state, after the first charge, and after the first discharge. In FIG. 3A, the y-axis 120 shows intensity (a.u.) and the x-axis 122 shows wavenumber (cm⁻¹). Pristine is designated 130, end of charge is designated 132, and end of discharge is designated 134. FIG. 3B shows the Raman spectra for 5% Si doped HE-NMC at the same three conditions. In FIG. 3B, the y-axis 140 shows intensity (a.u.) and the x-axis 142 shows wavenumber (cm⁻¹). Pristine is designated 150, end of charge is designated 152, and end of discharge is designated 154. Table 2 includes the position of the A_{1g} peak for samples at the three conditions. As the doping level increases the peak position is maintained. This suggests that doping mitigates the structure change without compromising capacity or limiting activation.

TABLE 2
Raman A_{1g} peak position evolution over the first cycle.

| | A_{1g} Peak Position (cm⁻¹) | | |
|---|---|---|---|
| Sample | Pristine | End of Charge | End of Discharge |
| Control | 590 | 610 | 610 |
| 2% Si | 595 | 595 | 610 |
| 5% Si | 590 | 590 | 600 |

Electrochemical Performance

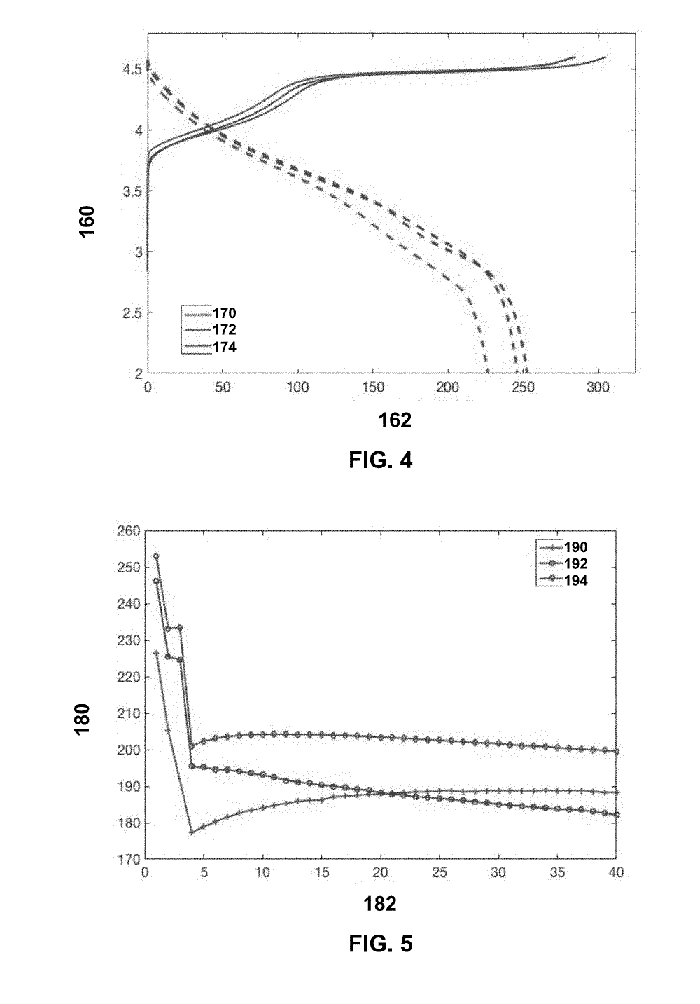

The voltage profiles from the first cycle of the synthesized materials can be seen in FIG. 4. FIG. 4 presents first cycle voltage profiles of control and Si doped HE-NMC at C/20. The y-axis 160 shows intensity (a.u.) and the x-axis 162 shows capacity (mAh/g). The control is designated 170, the 2% Si sample is designated 172, and the 5% sample is designated 174. The first charge profile is characterized by a large plateau around 4.5V. The discharge capacity of 5% Si doped HE-NMC is 253 mAh/g compared to 227 mAh/g for the control. The Si-doped samples have a prolonged sloping component, reaching the plateau at a higher capacity than the control. The overpotential of the Si-doped samples are reduced. FIG. 5 shows the higher discharge capacity of the 5% Si doped samples is maintained over forty cycles at C/3. The y-axis 180 shows discharge capacity (mAh/g) and the x-axis 182 shows cycle number. The control is designated 190, the 2% Si sample is designated 192, and the 5% sample is designated 194. The larger lattice could lead to the observed higher capacity by increasing Li⁺ ion mobility.

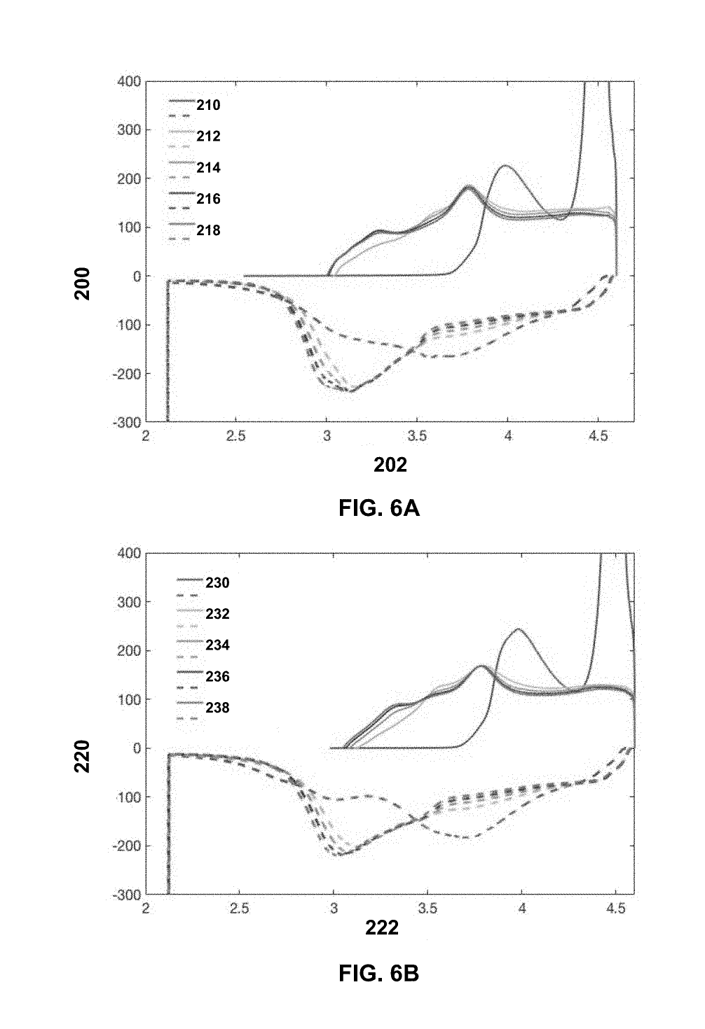

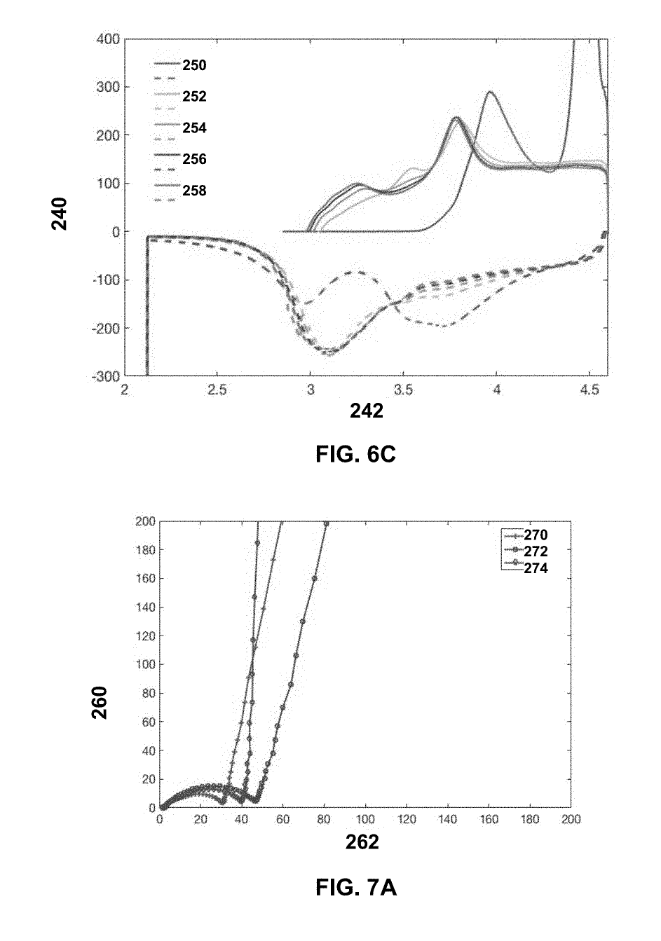

The evolution in the voltage profiles can easily be seen in the differential capacity plot in FIGS. 6A-6C for the 1^{st}, 12^{th}, 23^{rd}, 34^{th}, and 45^{th} cycle. In FIG. 6A, the y-axis 200 shows dQ/dV (mAh/gV) and the x-axis 202 shows voltage (V). A first discharge is designated 210, a 12^{th} discharge is designated 212, a 23^{rd} discharge is designated 214, a 34^{th} discharge is designated 216, and a 45^{th} discharge is designated 218. In FIG. 6B, the y-axis 220 shows dQ/dV (mAh/gV) and the x-axis 222 shows voltage (V). A first discharge is designated 230, a 12^{th} discharge is designated 232, a 23^{rd} discharge is designated 234, a 34^{th} discharge is designated 236, and a 45^{th} discharge is designated 238. In FIG. 6C, the y-axis 240 shows dQ/dV (mAh/gV) and the x-axis 242 shows voltage (V). A first discharge is designated 250, a 12^{th} discharge is designated 252, a 23^{rd} discharge is designated 254, a 34^{th} discharge is designated 256, and a 45^{th} discharge is designated 258. The first charge has anodic peaks from Ni²⁺/⁴⁺ and Co³⁺/⁴⁺ oxidation around 4V and a peak at the plateau around 4.5V. The anodic shoulder at 3.25V shifts to lower voltages with increasing cycle number, whereas the peaks around 3.6V and 3.8V shift to higher voltages with increasing cycle number. The discharge has cathodic peaks around 3.7V from Ni⁴⁺/²⁺ and Co⁴⁺/³⁺ reduction and a peak at 3V from the development of a spinel-like phase^{3,17}. The peaks around 3.7V and 3V shift to lower voltages, where the peak at 3V grows with cycle number while the peak at 3.7V shrinks. In the control material, the Mn⁴⁺/³⁺ reduction peaks become more intense with cycling as the Ni⁴⁺/²⁺ and Co⁴⁺/³⁺ reductions grow inactive. The 3V discharge peak of the Si doped HE-NMC is more stable than that of the control sample, indicating less spinel-like formation.

Resistance Measurements

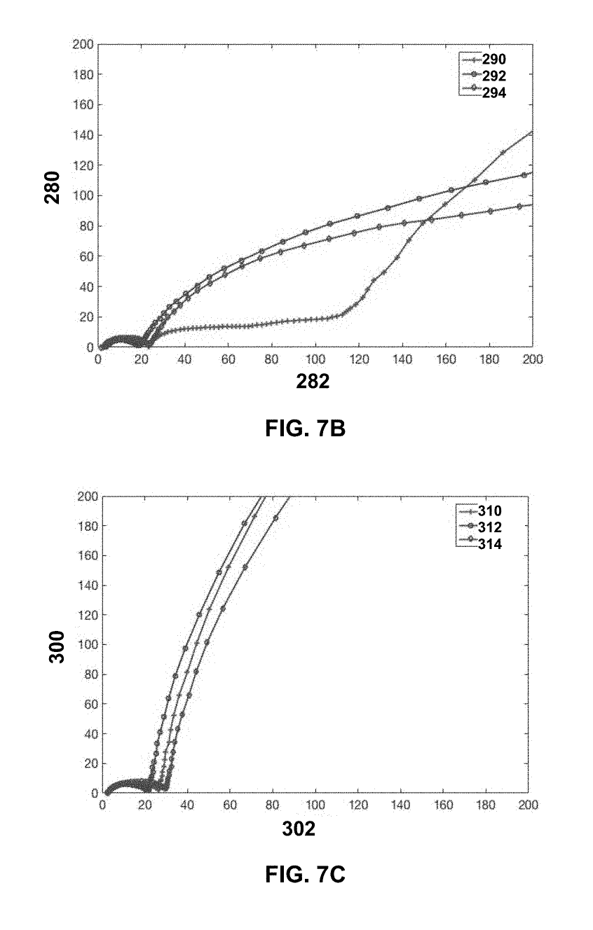

EIS measurements are used to separate contributions to the internal resistance in cells. FIG. 7A shows the impedance spectra after a 12-hour rest at the open circuit potential (OCP). In FIG. 7A, the y-axis 260 shows −1 m (Ω) and the x-axis 262 shows Re (Ω). The control is designated 270, the 2% Si sample is designated 272, and the 5% sample is designated 274. The high frequency semicircle provides information on the surface reactions and contact resistance in the cell, and the mid frequency region is related to charge transfer resistance at the electrode-electrolyte interface. The line in the low frequency region contains information on solid state diffusion and is referred to as the Warburg impedance. In FIG. 7A the ohmic resistance is similar among all samples, and the Si containing samples have larger semicircle diameters, corresponding to higher surface and interfacial resistances. These semicircles are overlapping, thus this qualitative analysis will not attempt to separate out the contributions from surface reactions and interfacial charge transfer resistances. The impedance spectra at the end of the first charge to 4.6 V is shown in FIG. 7B. In FIG. 7B, the y-axis 280 shows −1 m (Ω) and the x-axis 282 shows Re (Ω). The control is designated 290, the 2% Si sample is designated 292, and the 5% sample is designated 294. The control sample has a significantly higher ohmic resistance relative to the Si doped samples. This could be due to more oxygen release from surface changes in the control samples, changing the resistance of the electrolyte. The surface and interfacial resistances are also much higher in the control material, indicating a higher electrolyte reactivity. Si doping may help stabilize the electrolyte-electrode interface by lowering the interfacial resistance. HE-NMC is known to have high resistance at low states of charge, which is problematic for applications requiring pulse power capability. These findings suggest that Si doping lowers the resistance of HE-NMC. FIG. 7C shows the impedance spectra after the first discharge is similar for all samples. In FIG. 7C, the y-axis 300 shows −1 m (Ω) and the x-axis 302 shows Re (Ω). The control is designated 310, the 2% Si sample is designated 312, and the 5% sample is designated 314.

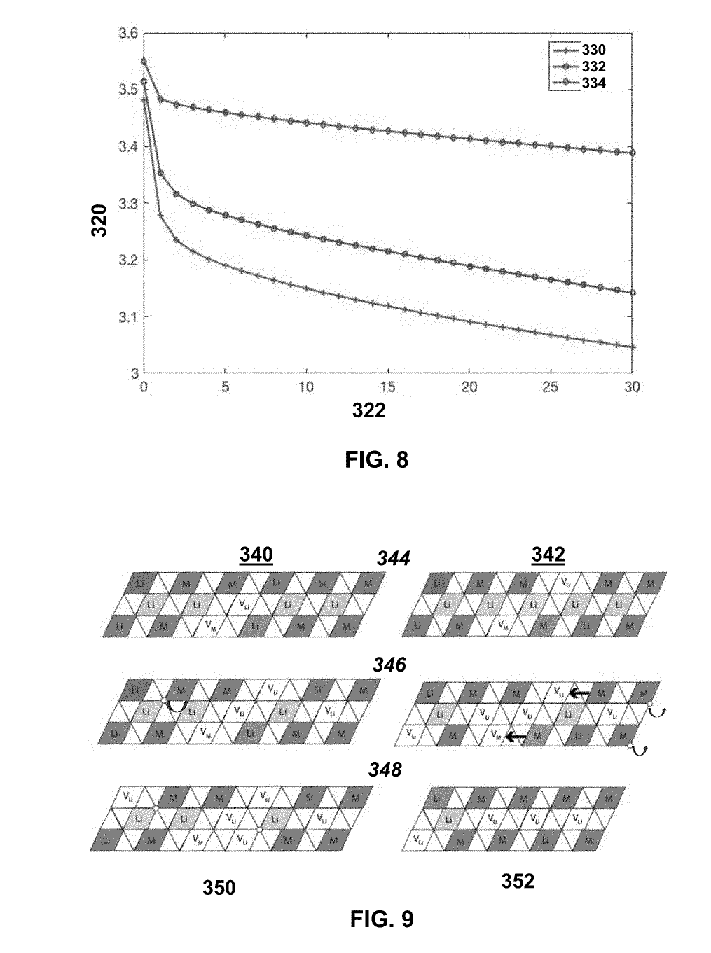

Direct Current Resistance (DCR) is a practical measure of internal resistance. It is collected using 1 C pulses at 50% SOC during the first discharge. FIG. 8 shows the voltage response during the 30 second pulse for the control, 2% Si (where x is 0.02), and 5% Si HE-NMC (where x is 0.05) samples. FIG. 8 shows DCR measurement results during a 30 s 1 C discharge pulse at 50% SOC for control and Si doped HE-NMC. The y-axis 320 shows voltage (V) and the x-axis 322 shows time (s). The control is designated 330, the 2% Si sample is designated 332, and the 5% sample is designated 334. The voltage drop can has two regimes, the first regime is the ohmic drop and occurs in the first second of the pulse step. As the doping level increases, the slope of the first regime segment decreases. The ohmic drop decreases with increased doping levels, supporting our impedance findings that Si doping reduces resistance.

Accordingly, HE-NMC can be successfully doped with Si using a co-precipitation synthetic method. At 5% Si doping levels trace amounts of a second phase was visible. The Si doped material shows increased capacity, with 5% Si HE-NMC having a 10% higher discharge capacity relative to the control. Because Si is not lithium active, the initial capacity was expected to be lower than the control. However, the larger lattice parameters and lower electrochemical impedance associated with Si doping may in fact have contributed to the increased capacity by making lithium extraction easier. Si doping likely changes the site energy to suppress Mn—O octahedral collapse and leads to less local structural change during activation.

The Raman results indicate that Si doping mitigates structural changes during the first cycle. EIS measurements show that the charge transfer resistance is much lower in the Si doped samples. DCR measurements at 50% SOC support this finding. The lower resistance of Si doped materials is consistent with the lower overpotential in the first charge voltage profile. The control sample has the highest resistance and reaches the activation plateau first.

Although the current teachings are not to be limited by theoretical considerations, FIG. 9 shows a model for a possible explanation of the increased capacity of Si doped HE-NMC. Li[Li,M]O₂(M=Ni,Co,Mn,Si) is designated 340, as where Li[Li,M]O₂(M=Ni,Co,Mn) is designated 342. The charge to 4.4 V is designated 344, the charge along a 4.5 V plateau is designated 346, and the end of charge is designated 348. The oxygen vacancies in the lattice are designated 350, while the lattice densification is designated 352. In both materials, initial charging to 4.4V oxidizes the transition metal ions and creates lithium and transition metal vacancies in the material. Along the plateau, more lithium is extracted by creating oxygen vacancies. In the Si-doped material (left), the oxygen vacancies hop but stay in the bulk. In the control material (right), the oxygen vacancies created at the surface are removed from the structure and the transition metal ions migrate to the bulk. By the end of the charge, the Si doped material has oxygen vacancies embedded within the lattice while the control material exhibits lattice densification.

The present teachings show that Si doping increases the capacity of HE-NMC and is attributed to the increased lattice parameters and lowered resistance during the first cycle.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A silicon-modified metal oxide comprising a compound having empirical formula
Li[Li_{y}Mn_{α-x}SiₓM^{III}_{b}M^{II}_{c}]O₂ (I)
wherein
y=0.01-0.33;
x=0.001-0.15;
a, b, and c are each greater than zero;
M^{III} is a trivalent metal or a combination of metals with an average valence of +3;
M^{II} is a divalent metal or a combination of metals with an average valence of +2; and
y+4a+3b+2c is equal to 3 or about 3.

2. The silicon-modified metal oxide according to claim 1, wherein y≥0.02.

3. The silicon-modified metal oxide according to claim 1, wherein y≥0.05.

4. The silicon-modified metal oxide according to claim 1, wherein x≥0.02.

5. The silicon-modified metal oxide according to claim 1, wherein x≥0.05.

6. The silicon-modified metal oxide according to claim 1, wherein x≥0.07.

7. The silicon-modified metal oxide according to claim 1, wherein M^{III} comprises Co and M^{II} comprises Ni.

8. The silicon-modified metal oxide according to claim 1, wherein a>0.3.

9. The silicon-modified metal oxide according to claim 1, wherein a is 0.3-0.67.

10. A lithium ion battery comprising an anode, a cathode, and a separator disposed between the anode and cathode, wherein the cathode comprises a mixed metal oxide compound according to claim 1.

11. The lithium ion battery of claim 10, wherein the mixed metal oxide compound has an empirical Formula (II):
Li[Li_{0.2}Mn_{0.49}Si_{0.05}Ni_{0.13}Co_{0.13}]O₂ (II).

12. A method for synthesizing a silicon-modified metal oxide according to claim 1, comprising:
combining soluble salts comprising Mn²⁺, Ni⁺², and Co⁺² in an aqueous solution;
co-precipitating hydroxide salts as solids from the aqueous solution with base;
collecting co-precipitated solids;
combining the solids with lithium hydroxide and a silicon compound; and
calcining a resulting composition in air at a temperature sufficient to calcine the materials to make a composition according to claim 1.

13. The method according to claim 12, wherein M^{III} comprises Co and M^{II} comprises Ni.

14. The method according to claim 12, comprising calcining at a temperature of 600-1200° C.

15. The method of claim 12, wherein the silicon compound comprises silicic acid.

16. The method of claim 12, wherein the silicon compound comprises a siloxane or polysiloxane.

17. The method of claim 12, wherein the silicon compound is a solid.

18. A method of operating a lithium ion battery comprising:
providing a lithium ion battery comprising an anode, a cathode, and a separator disposed between the cathode and anode, wherein the cathode comprises a battery active material prepared in a discharged state; and
applying a voltage difference between the cathode and anode to de-lithiate the battery active material in the cathode and charge the lithium ion battery, wherein the battery active material comprises a mixed metal oxide having empirical formula
Li[Li_{y}Mn_{α-x}SiₓM^{III}_{b}M^{II}_{c}]O₂ (I)
wherein
y=0.01-0.33; a=0.3-0.67; x=0.001-0.15; and b and c are both greater than zero;
M^{III} is a trivalent metal or a combination of metals with an average valence of +3;
M^{II} is a divalent metal or a combination of metals with an average valence of +2; and
y+4a+3b+2c is equal to about +3 or about +3.

19. The method according to claim 18, wherein M^{III} comprises cobalt and M^{II} comprises nickel.

20. The method of claim 18, wherein x≥0.01 and y≥0.1.
